(19) United States
(12) Patent Application Publication
(10) Pub. No.: US 2016/0091040 A1
(43) Pub. Date: Mar. 31, 2016

(54) MULTI-LAYER FRICTION LINING

(71) Applicant: SCHAEFFLER TECHNOLOGIES AG & CO. KG, Herzogenaurach (DE)

(72) Inventor: Jens Ludes, Beckingen (DE)

(73) Assignee: Schaeffler Technologies AG & Co. KG, Herzogenaurach (DE)

(21) Appl. No.: 14/891,786

(22) PCT Filed: May 21, 2014
(86) PCT No.: PCT/DE2014/200231

§ 371 Date: Nov. 17, 2015

(30) Foreign Application Priority Data
Jun. 4, 2013 (DE) 10 2013 210 290.9

(51) Int. Cl. F16D 69/02

(52) U.S. Cl. CPC F16D 69/023; F16D 69/02; F16D 2069/008

(57) ABSTRACT

A multi-layer friction lining is provided, in particular a clutch friction lining including a friction part and a reinforcement part. The invention is characterized in that the reinforcement part comprises a woven fabric.

### BACKGROUND

The invention relates to a multi-layer friction lining, particularly a clutch friction lining, comprising a friction part and a reinforcement part.

From the international publication WO 2007/121704 A2 a two-layer clutch lining is known, which comprises a friction part and a reinforcement part, with the reinforcement part being wound from a reinforcement yarn and the friction part being wound from a friction yarn. From the German patent publication DE 44 31 642 B4 a friction lining is known with a circular form, comprising fibers, binders, and fillers. From the German publication DE 10 2008 064 478 A1 a friction lining is known, comprising an annular friction part made at least from thread material and binders and an annular carrier part. From the international publication WO 2011/160616 A2 a method is known for adhering a friction lining.

### SUMMARY

The objective of the invention is to provide a multi-layer friction lining with a friction part and a reinforcement part, which exhibits a low layer thickness and high strength.

The objective is attained in a multi-layer friction lining, particularly a clutch friction lining comprising a friction part and a reinforcement part, in that the reinforcement part comprises a web. In modern motor vehicles, due to the small structural space, increasingly clutch linings are required for the clutch exhibiting a layer thickness as low as possible. This leads to the friction coatings increasingly being stressed to a greater extent during the operation of the clutch. Accordingly, high requirements are set to the strength of the friction linings. Simultaneously, due to the reduced overall layer thickness the thickness of the rivet base available also becomes considerably smaller. Within the scope of the present invention it was found that the use of a web in the reinforcement part can considerably increase the strength of the friction lining.

A preferred exemplary embodiment of the multi-layer friction lining is characterized in that the web comprises reinforcement fibers or reinforcement fiber bundles, which are woven with warps and wefts. The term warp and/or warp thread and weft and/or weft thread are known from weaving technology. For example, warp marks reinforcement fibers or reinforcement fiber bundles arranged in a longitudinal direction. Weft indicates reinforcement fibers or reinforcement fiber bundles arranged perpendicular in reference thereto. Warp and weft are arranged crossing each other.

Another preferred exemplary embodiment of the multi-layer friction lining is characterized in that the web comprises reinforcement fibers or reinforcement fiber bundles, which are arranged spirally. Here, the reinforcement fibers or reinforcement fiber bundles may be arranged spirally in several layers. The spirally arranged reinforcement fibers or reinforcement fiber bundles may also be interwoven with each other. Here, the spiral arrangement of the reinforcement fibers or reinforcement fiber bundles may be performed identically or similarly as in the laying technology of heating systems.

Another preferred exemplary embodiment of the multi-layer friction lining is characterized in that the friction part comprises wound fibers or fiber bundles. The friction part may be embodied identically or similarly to friction parts in conventional friction linings.

Another preferred exemplary embodiment of the multi-layer friction lining is characterized in that the friction lining is formed in two layers, including the friction part and the reinforcement part. This way, in a simple fashion the generation of a very low lining thickness is possible.

Another preferred exemplary embodiment of the multi-layer friction lining is characterized in that the friction lining is formed in three layers, including the friction part, the reinforcement part, and a carrier part. By the additional carrier part the strength of the friction lining can be further increased. The carrier part can here be generated identically or similarly to conventional friction linings.

Another preferred exemplary embodiment of the multi-layer friction lining is characterized in that the reinforcement part is arranged between the carrier part and the friction part. This arrangement has proven particularly advantageous with regards to the strength of the friction lining within the scope of the experiments performed for the present invention.

Another preferred exemplary embodiment of the multi-layer friction lining is characterized in that the carrier part comprises wound fibers or fiber bundles. The combination of the woven fabric in the reinforcement part with the wound fibers or fiber bundles in the carrier part has proven advantageous within the scope of the experiments performed for the present invention with regards to the strength of the friction lining.

Another preferred exemplary embodiment of a multi-layer friction lining is characterized in that the friction part and the reinforcement part are essentially embodied annularly and arranged directly on top of each other, forming a separating plane. Here, the friction part and the reinforcement part and perhaps also the carrier part are arranged such that they form a laminate, with the friction part and the reinforcement part as well as perhaps the reinforcement part and the carrier part each being mixed in the area of the separating plane.

Another preferred exemplary embodiment of the multi-layer friction lining is characterized in that the woven fabric comprises fiberglass/carbon fibers or fiberglass bundles/carbon fiber bundles. The fibers or fiber bundles are advantageously impregnated, for example with a phenol resin.

The invention perhaps also relates to a method for the production of one of the above-described multi-layer friction linings, particularly a two-layer or three-layer clutch lining.

### BRIEF DESCRIPTION OF THE DRAWINGS

Additional advantages, features, and details of the invention are discernible from the following description, in which various exemplary embodiments are described in detail with reference to the drawings. Shown are:

FIG. 1 a largely simplified illustration of a two-layer friction lining according to a first exemplary embodiment of the invention in a cross-section, and

FIG. 2 a simplified illustration of a three-layer friction lining according to a second exemplary embodiment of the invention in a cross-section.

### DETAILED DESCRIPTION OF THE PREFERRED EMBODIMENTS

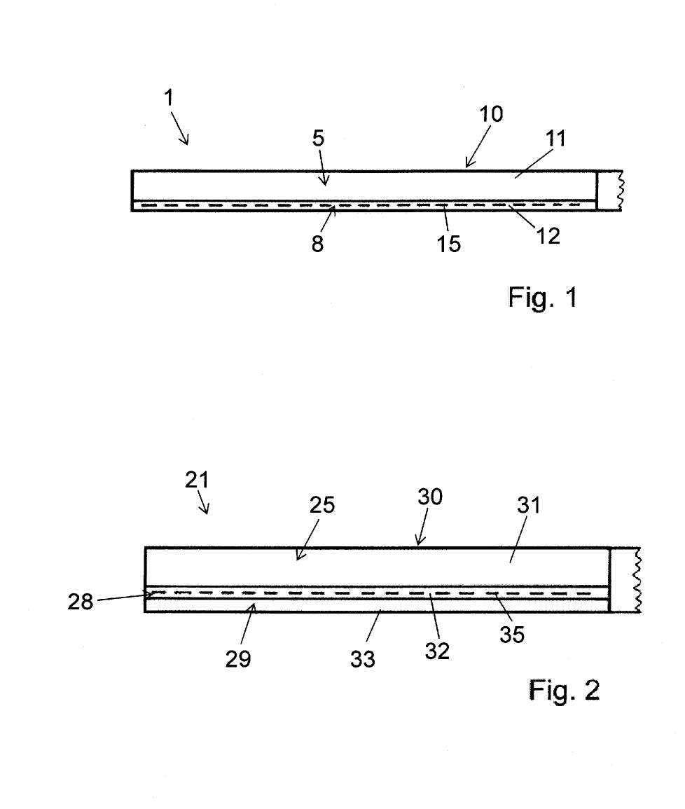

FIGS. 1 and 2 each show a friction lining 1; 21 according to the invention in a cross-section. The friction linings 1; 21 represent clutch friction linings, which are fastened at a clutch disk (not shown). The clutch disk essentially comprises identical clutch linings 1 or 21. The two clutch linings 1; 21 are connected to each other with the help of rivets at both sides of elastic lining segments such that friction parts 5; 25 of the friction linings 1; 21 are facing outwardly.

The friction lining 1 shown in FIG. 1 comprises, in addition to the friction part 5, a reinforcement part 8. In FIG. 1 the friction part 5 and the reinforcement part 8 are shown in a cross-section 10. The cross-section 10 represents a rectangular cross-section of the ring, which in reality is longer and thinner than in the illustration.

The friction part 5 comprises a friction layer 11. The reinforcement part 8 comprises a reinforcement layer 12. The dot-dash line 15 indicates a web, which is embedded in the reinforcement layer 12.

The friction layer 11 serves to form a friction side of the friction lining 1. The friction side of the friction lining 1 is generated by winding, for example. The application of the winding method to produce friction parts of clutch linings is known from prior art.

By the reinforcement layer 12 comprising the woven fabric web 15 the strength of the friction lining 1 can be considerably increased. The web 15 is designed from warps and wefts according to one exemplary embodiment of the invention. According to another exemplary embodiment of the invention the web 15 is designed in a spiral arrangement. By the combination of the reinforcement layer 12 with the web 15 comprising a wound friction layer 11 here clutch disks can be produced with low friction layer thicknesses, which are suitable to transmit very strong torque.

The friction lining 21 shown in FIG. 2 comprises, in addition to the friction part 25, a reinforcement part 28 and a carrier part 29. The friction part 21 has a slightly thicker cross-section 30 than the friction lining 1 in FIG. 1. The cross-section 30 comprises a friction layer 31, a reinforcement layer 32, and a carrier layer 33. The dot-dash line 35 indicates that a web is embedded in the reinforcement layer 32.

Similar to the previous exemplary embodiment, the web 35 is woven with warps and wefts or has a spiral arrangement. The friction layer 31 is embodied identical to the friction layer 11 of the friction lining 1 shown in FIG. 1. The carrier layer 33 is wound and represents a carrier side of the friction lining 21.

The friction linings 1; 21 differ from friction linings of prior art primarily in the use of the web 15; 35 for the reinforcement of the friction lining and/or the rivet base. The web 15; 35 comprises a fiberglass bundle, for example. The fiberglass bundle can be used with or without impregnation, for example using phenol resin. Instead of fiberglass, here carbon fibers may be used as well.

By the use of the web, which is advantageously produced with the warps and wefts, the strength of the rivet base of the friction lining 1; 21 can be considerably increased. Furthermore the overall impact strength can be increased.

### LIST OF REFERENCE CHARACTERS

1 friction lining
5 friction part
8 reinforcement part
10 cross-section
11 friction layer
12 reinforcement layer
15 dot-dash line
21 friction lining
25 friction part
28 reinforcement part
29 carrier part
30 cross-section
31 friction layer
32 reinforcement layer
33 carrier layer
35 dot-dash line

1. A multi-layer friction lining, comprising a friction part and a reinforcement part, that comprises a web.

2. The multi-layer friction lining according to claim 1, wherein the web comprises reinforcement fibers or reinforcement fiber bundles, which are woven with warps and wefts.

3. The multi-layer friction lining according to claim 2, wherein the web comprises reinforcement fibers or reinforcement fiber bundles, which are arranged spirally.

4. The multi-layer friction lining according to claim 1, wherein the friction part comprises wound fibers or fiber bundles.

5. The multi-layer friction lining according to claim 1, wherein the friction lining is formed in two layers with the friction part and the reinforcement part.

6. The multi-layer friction lining according to claim 1, wherein the friction lining is formed in three layers with the friction part, the reinforcement part, and a carrier part.

7. The multi-layer friction lining according to claim 6, wherein the reinforcement part is arranged between the carrier part and the friction part.

8. The multi-layer friction lining according to claim 6, wherein the carrier part comprises wound fibers or fiber bundles.

9. The multi-layer friction lining according to claim 1, wherein the friction part and the reinforcement part are embodied annularly and arranged directly on top of each other forming a separating plane.

10. The multi-layer friction lining according to claim 1, wherein the web comprises at least one of fiberglass, carbon fibers, fiberglass bundles, or carbon fiber bundles.
